(19) United States
(12) Patent Application Publication
(10) Pub. No.: US 2008/0012414 A1
(43) Pub. Date: Jan. 17, 2008

(54) Armchair

(76) Inventor: Eckhart Dewert, Zurich (CH)

Correspondence Address: SHLESINGER, ARKWRIGHT & GARVEY LLP, 1420 KING STREET, SUITE 600, ALEXANDRIA, VA, 22314, US

(21) Appl. No.: 11/826,538

(22) Filed: Jul. 16, 2007

Related U.S. Application Data
(63) Continuation of application No. PCT/EP2005/012957, filed on Dec. 3, 2005.

(30) Foreign Application Priority Data
Jan. 14, 2005 (DE) 20 2005 000 574.6

(51) Int. Cl. B60N 2/20

(52) U.S. Cl. 297/354.11

(57) ABSTRACT

Chair, such as an armchair, includes a backrest. The backrest includes at least two backrest parts, which are connected to one another, which can be angularly displaced, and which are adjustable relative to one another. As a result of the adjustability of the backrest parts relative to one another, the armchair offers numerous adjustment possibilities.

### CROSS-REFERENCE TO RELATED APPLICATIONS

This application is a continuation of application no. PCT/EP2005/012957, filed Dec. 3, 2005, which claims the priority of German application no. 20 2005 000 574.6, filed Jan. 14, 2005, and each of which is incorporated herein by reference.

### FIELD OF THE INVENTION

The invention relates to a chair. More particularly, the invention relates to an armchair. Even more particularly, the invention relates to an armchair including a base body provided with a backrest to support a person reposing on an armchair in the person's back region.

### BACKGROUND OF THE INVENTION

Armchairs of this type are known in general, for example from WO2004/062435 A1, DE 299 19 238 U1, DE 298 00 197 U1, DE 201 00 733 and U.S. Pat. No. 2,790,485. They comprise a base body provided with a backrest to support a person reposing on the armchair in the back region.

### OBJECTS AND SUMMARY OF THE INVENTION

It is therefore an object of the invention to provide an armchair of the type with increased comfort for the user.

This object is achieved with the teaching set forth below. The basic idea of the teaching according to the invention is to provide the backrest with at least two backrest parts, which are connected to one another, and which can be angularly displaced, and are adjustable relative to one another. As a result of the adjustability of the backrest parts relative to one another, the armchair according to the invention offers numerous adjustment possibilities.

For example and in particular, the backrest parts can be adjusted relative to one another such that they form a common, substantially horizontal support surface, so that optionally in conjunction with further support parts of the armchair, such as a seat part and/or a calf support part and/or a headrest part, a reclining surface is formed and the armchair in this adjustment position forms a part of reclining furniture.

In a further adjustment position, the first backrest part, for example and in particular, may be disposed substantially vertically so that it forms a backrest, while the second backrest part is adjusted such that it is disposed behind the first backrest part when viewing the armchair from the front. In this position, the armchair can be used as a part of seating furniture, wherein disposing the second backrest part behind the first backrest part has the advantage that the armchair in this position has a compact and visually appealing design because the overall “old-fashioned” aesthetic appearance of recliners with long backrests, for example, is being avoided. In the sitting position, the armchair may have, for example, a substantially cubic design, as is known from the ‘Bauhaus style’, for example.

Beyond that, the backrest parts can be displaced, for example and in particular, in an adjustment position in relation to one another, in which they form a common support surface, which however is not configured substantially level, but instead has a concave or convex shape as desired by the user, for example in order to form a lumbar support in the lumbar region of the user.

A backrest part according to the invention only refers to such support parts of such an armchair, which serve the support of a person in the back region. Accordingly, a parting line extends between the backrest parts in the longitudinal region of the backrest in a region, in which the user's back is supported when the armchair is in use.

According to the invention, it is sufficient in principle if the backrest is formed by two backrest parts. In the event it should be necessary to meet particular requirements, however, also more than two backrest parts may be provided.

One further development of the invention provides that the backrest parts can be displaced relative to one another between a first adjustment position, in which the support sides of the backrest parts point substantially in the same direction such that the support parts form a common support surface, and a second adjustment position, in which the support sides of the backrest parts point away from each other. In the first adjustment position, the support sides form, for example and in particular, a substantially horizontal and substantially continuous support surface, while the support parts in the second adjustment position may be disposed substantially parallel to each other, so that, for example in the front view of the armchair, the support surface of the first backrest part points forward and the support surface of the second backrest part points backward. The support side of a support part according to the invention shall be understood as that side or surface, on which the user's body is supported when the armchair is in use.

A further development of the embodiment mentioned above provides that in the second adjustment position the backs of the backrest parts facing away from the support sides face each other, in particular resting against each other at least in some areas. In this way, a particularly compact design is achieved in the second adjustment position.

Expediently, a seat part of the armchair may be connected to the end of the first backrest part facing away from the second backrest part. In a reclining position of the armchair, the seat part, for example, may form a common, substantially horizontal and substantial support surface together with the backrest parts.

A further development of the above-described embodiment provides that, in a first adjustment position of the first backrest part relative to the seat part, the support sides of the first backrest part and seat part point substantially in the same direction, such that the first backrest part and the seat part in this adjustment position form a common support surface, while in a second adjustment position the support side of the first backrest part and seat part form an acute angle with each other. In this embodiment, the first adjustment position may correspond, for example, to a reclining position of the armchair, while the second adjustment position may correspond to a sitting position, in which the first backrest part is disposed substantially perpendicular or at an incline to the seat part.

So as to further expand the adjustment possibilities and hence the comfort level for the user, another further development of the teaching according to the invention provides that a headrest part is connected to the end of the second backrest part facing away from the first backrest part, the headrest part being angularly displaceable and adjustable relative to the second backrest part. In this embodiment, a headrest part is provided in the region of the head, which is to say in the longitudinal direction of the backrest directly following the second backrest part, the headrest part providing support in the region of the user's head. In addition, the reclining surface is extended by the headrest part in the reclining position of the armchair.

A further development of the above embodiment provides that, in a first adjustment position of the headrest part relative to the second backrest part, the support sides of the headrest part and of the backrest part point substantially in the same direction such that the headrest part and the second backrest part form a common support surface, while in a second adjustment position the support sides of the second backrest part and of the headrest part point away from each other. In this embodiment, the first adjustment position may correspond, for example, to a reclining position, in which the backrest parts together with the headrest part form a common reclining surface, while the second adjustment position may correspond to a sitting position, in which the headrest part is disposed behind the first backrest part and is thus concealed by this backrest part when viewing the armchair from the front.

A further development of the embodiments comprising the headrest part provides that, in the second adjustment position of the headrest part relative to the second backrest part, the backs of the headrest part facing away from the support sides and of the second backrest part face each other, particularly rest against each other at least in some areas. In this embodiment, a particularly compact armchair design is achieved in the second adjustment position.

So as to further expand the adjustment possibilities and hence improve the comfort level for the user, a further development of the teaching according to the invention provides that a calf support part is connected to the end of the seat part facing away from the first backrest part in an angularly displaceable and adjustable manner. The calf support part ensures support of the calf or leg region of a person reposing on the armchair and hence increases the comfort level.

Furthermore, in an appropriate adjustment position, the calf support part enables a reclining surface formed by the seat part, the backrest parts and optionally the headrest part to be extended even further, so that in the reclining position of the armchair also tall users can rest comfortably on the reclining surface.

The connection of the support parts with one another can be selected within a wide range as a function of the respective kinematics. So as to configure the design in a simple and therefore more cost-efficient manner, a further development of the invention provides that the first backrest part is pivotably connected to the second backrest part and/or the first backrest part is pivotably connected to the seat part and/or the second backrest part is pivotably connected to the headrest part and/or the seat part is pivotably connected to the calf support part, each about at least one pivot axis.

According to the invention, it is possible in principle to manually adjust the support parts relative to one another. So as to further increase the comfort level for the user, an expedient further development of the invention provides that the first backrest part is displaceable relative to the second backrest part and/or the first backrest part is displaceable relative to the seat part and/or the headrest part is displaceable relative to the backrest part and/or the calf support part is displaceable relative to the seat part by an electromechanical drive device.

One extraordinarily advantageous further development of the teaching according to the invention provides that, in a reclining position of the armchair, the support sides of the calf support part, of the seat part, of the first backrest part and of the second backrest part and preferably of the headrest part form a common reclining surface such that the armchair forms a reclining part of furniture. In this embodiment, the armchair can be used simply as a seating part of furniture or simply as a reclining part of furniture or, in an appropriate adjustment position, also as a lounger and can therefore be used a combined seating and reclining part of furniture.

A further solution for the object of the invention is provided as set forth below.

In this solution, according to which at least one first support part and one second support part are disposed on the base body, wherein the support parts comprise support surfaces for supporting a person reposing on the armchair, it is provided according to the invention that the first support part can be displaced relative to the second support part between a first adjustment position, in which the support parts are disposed on top of each other in the direction of a reference line on at least one of the support surfaces, and a second adjustment position, in which the support parts are disposed in line next to each other and the support surfaces thereof form a common, particularly substantially continuous support surface. According to the invention, in the first adjustment position the first support part and the second support part may form, for example and in particular, part of a reclining surface, while in the second adjustment position the support parts are disposed on top of each other. For example and in particular, the first support part may be formed by a seat part and the second support part may be formed by a calf and/or leg support part, wherein in the second adjustment position the calf support part is disposed underneath the seat part and is therefore visually hidden.

A further development of the above embodiment provides that the first support part is disposed underneath the second support part in the first adjustment position.

The adjustment kinematics of the first support part relative to the second support part can be selected within a wide range as a function of the respective requirements. Further developments of the teaching according to the invention provide that between the first adjustment position and the second adjustment position the first support part performs a pivot motion at least in some areas and/or that between the first adjustment position and the second adjustment position the first support part performs a linear translatory motion at least in some areas. According to the invention, it is also possible that the first support part performs both a pivot motion and a linear translatory motion, wherein a pivot motion may be combined in any desired manner with a linear translatory motion, optionally in different kinematic phases, as a function of the respectively required kinematics.

According to a particularly advantageous further development of the teachings according to the invention, the first support part is guided on the second support part by use of a sliding block guide. This embodiment provides a particularly stable design. Furthermore, as a result of the course of the sliding block guide, the kinematics can be selected as a function of the respective requirements.

Further developments of the above embodiments provide that the sliding block guide has a straight section and/or that the sliding block guide has a curved section and/or a section extending at an angle to a straight section such that the first support part performs a pivot motion when passing this section.

According to a particularly advantageous further development of the above embodiment, the curved and/or angled section extends such that the sliding block guide lifts the rear end of the first support part in the adjustment direction when the first support part is displaced in the second adjustment position. In this embodiment, for example, the rear end of a calf support part is lifted with the passing of the sliding block guide, so that at the end of the lifting movement the support surface of this part has substantially the same height as the support surface of a seat part and the support surfaces of the calf support part and of the seat part can form a substantially continuous, for example, substantially horizontal, support surface, with each other.

According to one extraordinarily advantageous further development of the invention, a device is provided, which lowers the front end of the first support part in the adjustment direction, when displacing the first support part in the second adjustment position as the first support part passes the curved or angled section, such that the support surface of the first support part is or remains disposed substantially horizontally when passing the curved or angled section of the sliding block guide. This device compensates for a pivoting of the front end of the first support part in the adjustment direction, the pivoting occurring as a result of the pivot motion when the rear end is lifted in the adjustment direction, so that at the end of the adjustment motion, optionally also during the adjustment motion, the support side of the first support part assumes a substantially horizontal position.

So as to configure the design in a simple and hence cost-efficient manner for the above embodiment, a further development provides that, as the first support part passes the curved or angled section of the sliding block guide, the rear end of the first support part in the adjustment direction is pivoted about a first pivot axis with a displacement in the second adjustment position, while the front end of the first support part in the adjustment direction is pivoted about a second pivot axis in the opposite direction, the second axis being substantially parallel to the first pivot axis.

The invention will be explained in more detail hereinafter with reference to the figures illustrated in the drawings, showing one exemplary embodiment of an inventive armchair. All described or illustrated characteristics, either alone or in any desired combination, represent the subject matter of the invention, regardless of their formulation in the claims, as well as regardless of their formulation and/or illustration in the description and/or figures.

The figures are in part phantom views and in part schematic views, wherein for reasons of clarity some components have been eliminated.

### BRIEF DESCRIPTION OF THE DRAWINGS

FIG. 1 is a perspective view of one exemplary embodiment of an inventive armchair,

FIG. 2 is a perspective view of a calf support part of the armchair,

FIG. 3 is a perspective view of a detail of an adjustment mechanism for adjusting the calf support part relative to a seat part,

FIG. 4 is a perspective view of a detail in the area of a backrest part,

FIG. 5 is, in the same manner of illustration as in FIG. 4, a further detail in the region of the backrest part,

FIG. 6 is a side view of the armchair in a sitting position,

FIG. 7 is, in the same manner of illustration as in FIG. 6, the armchair according to FIG. 6 during an adjustment from the sitting position shown in FIG. 6,

FIG. 8 is, in the same manner of illustration as in FIG. 6, the armchair according to FIG. 6 during an adjustment from the sitting position in a further kinematic phase, and

FIG. 9 is, in the same manner of illustration as in FIG. 6, the armchair according to FIG. 6 in a reclining position.

### DETAILED DESCRIPTION OF THE INVENTION

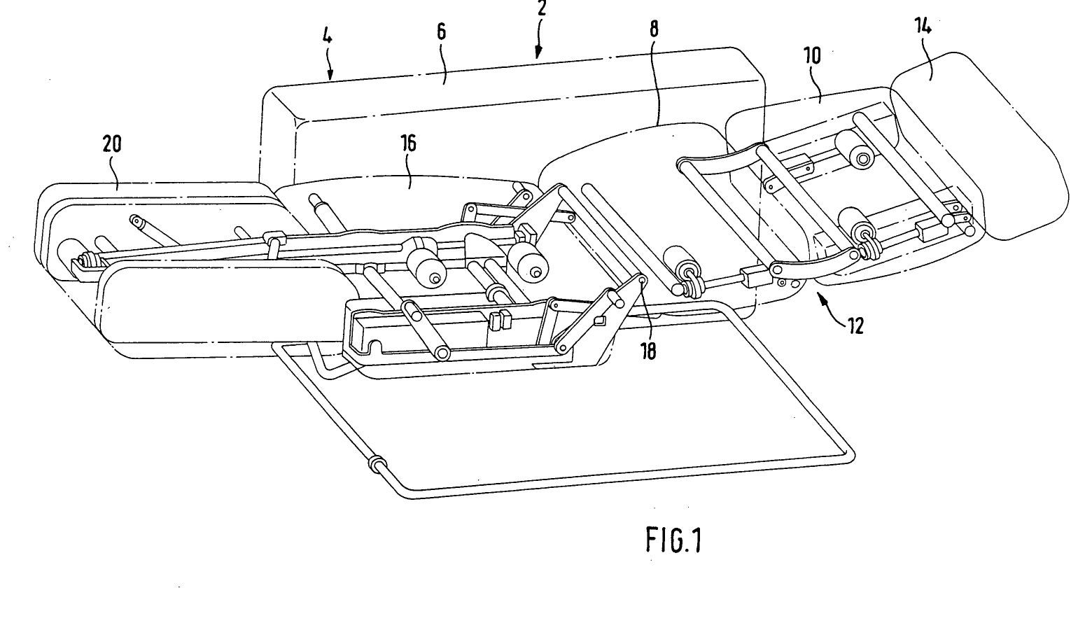

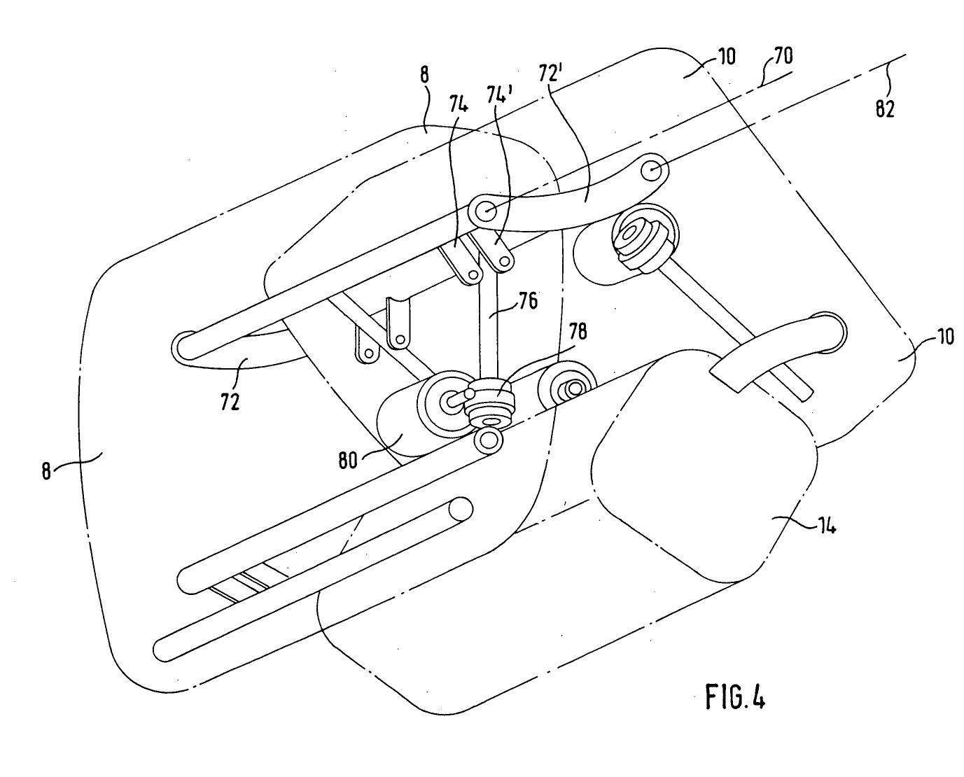

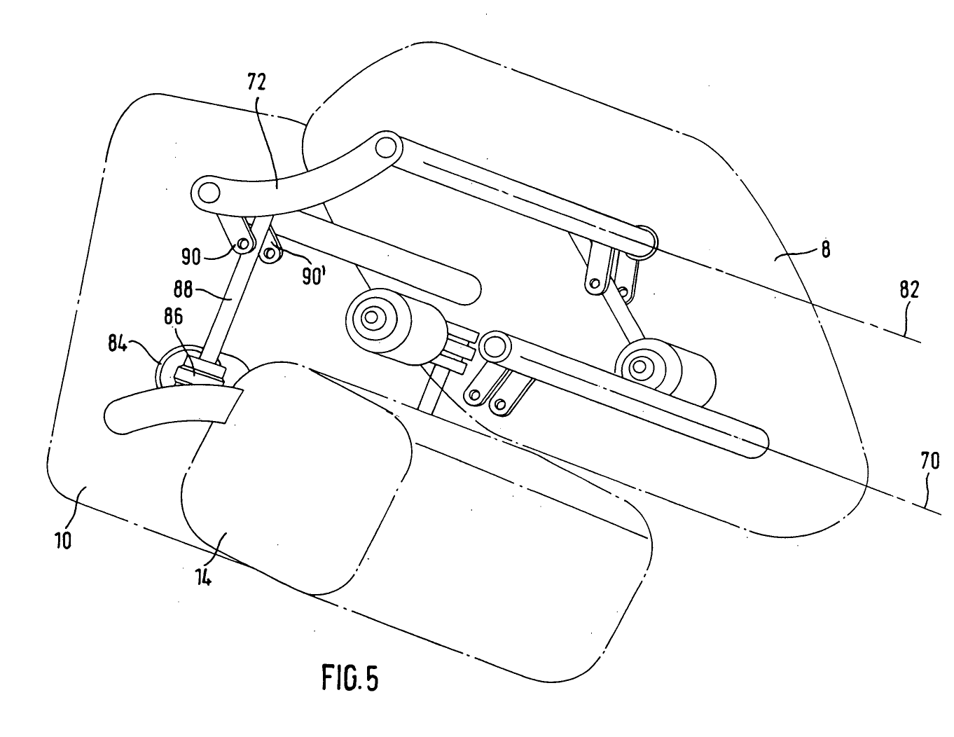

FIG. 1 shows one exemplary embodiment of an inventive armchair 2, comprising a base body 4 with lateral armrests, of which only one armrest 6 is shown in FIG. 1. On the base body 4, a backrest is provided to support a person reposing on the armchair in the back region, wherein the backrest in this exemplary embodiment is provided with, according to the invention, a first backrest part 8 and a second backrest part 10, which are connected to one another and can be angularly displaced and adjusted relative to each other. An adjusting mechanism 12 for adjusting the first backrest part 8 relative to the second backrest part 10 will be explained in more detail below with reference to FIGS. 4 and 5.

A headrest part 14 is connected in an angularly displaceable manner to the end of the second backrest part 10 facing away from the first backrest part 8. An adjusting mechanism 12 for adjusting the headrest part 14 relative to the second backrest part 10 will be explained in more detail below with reference to FIGS. 4 and 5.

The first backrest part 8 is connected at the end thereof facing away from the second backrest part 10 to a support part 16 in an angularly displaceable manner, which is to say about a substantially horizontal first pivot axis 18, wherein an electromechanical drive device, e.g., an electric motor, is provided for pivoting the first backrest part 8 relative to the seat part 16.

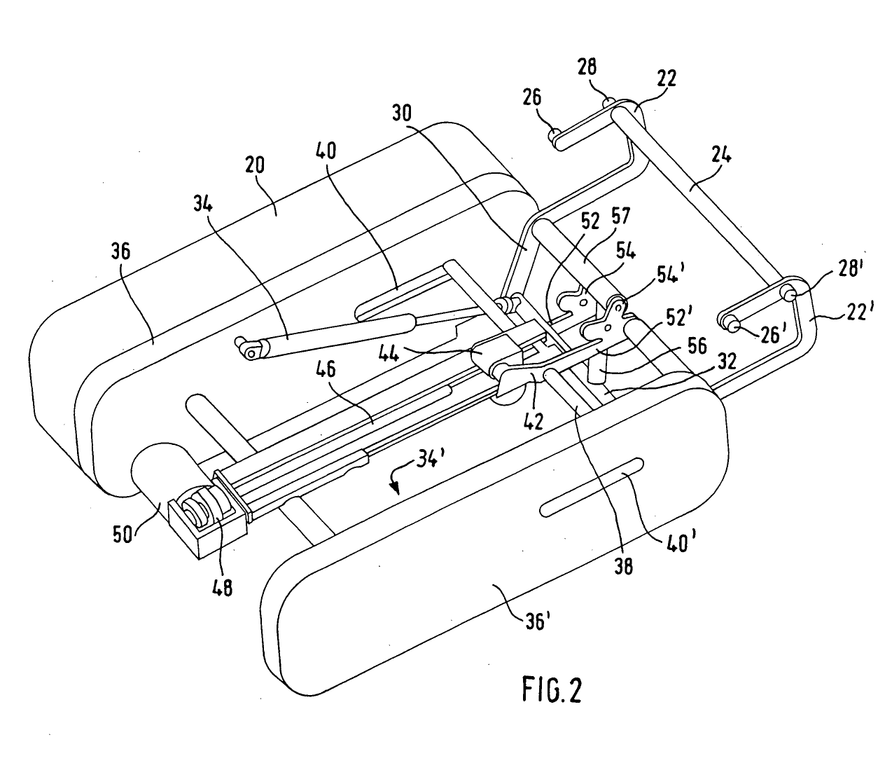

A calf support part 20 is connected in an angularly displaceable manner to the end of the seat part 16 facing away from the first backrest part 8. An adjusting mechanism for adjusting the calf support part 20 relative to the seat part 16 will be explained in more detail below with reference to FIGS. 2 to 4.

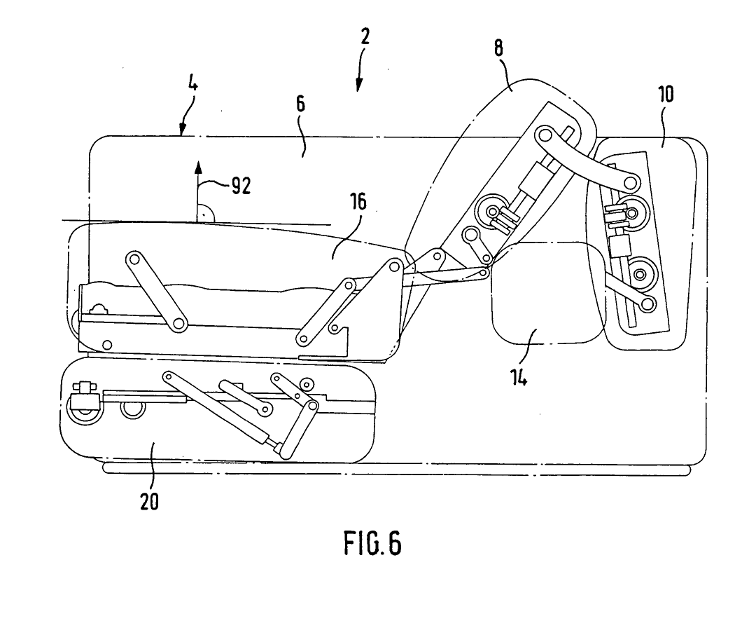

According to the invention, the calf support part 20 is adjustable relative to the seat part 16 between a first adjustment position, in which the support parts 16, 20 are disposed on top of each other in the direction of an imaginary reference line which is perpendicular to at least one of the support surfaces (see FIG. 6), and a second adjustment position shown in FIG. 1, in which the calf support part 20 and the seat part 16 are disposed in line next to each other and the support surfaces thereof form a common, substantially continuous support surface. In the adjustment position of the armchair 2 shown according to FIG. 1, the calf support part 20, the seat part 16, the first backrest part 8, the second backrest part 10 and the headrest part 14 form a common, substantially continuous reclining surface, so that the armchair 2 in this adjustment position forms a reclining part of furniture.

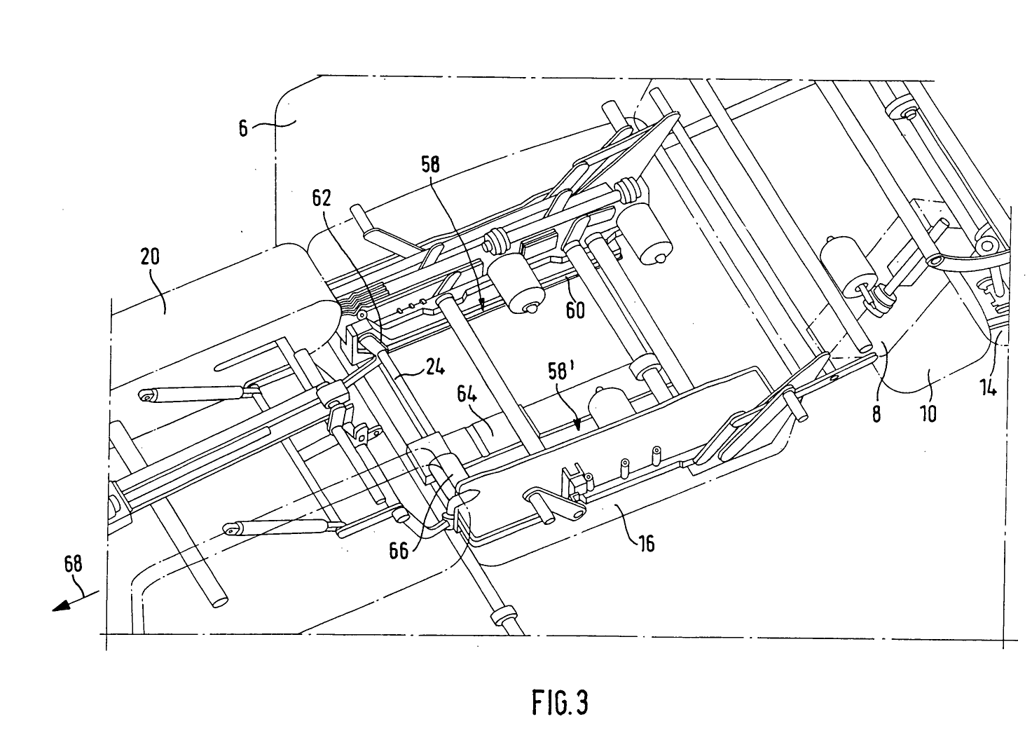

FIG. 2 shows part of an adjusting mechanism for adjusting the calf support part 20 relative to the seat part 16. The adjusting mechanism comprises two levers 22, 22′, which are laterally disposed at a distance from each other and in the side view are substantially C-shaped and which are rigidly connected to one another by a brace 24. In the region of the upper end according to FIG. 2, the levers 22, 22′ comprise pins 26, 28 or 26′, 28′, which are used to guide the calf support part 20 in a sliding block guide formed on the seat part 16, which will be explained in more detail below with reference to FIG. 3.

In the region of the end facing the calf support part 20, the lever 22 has an angled extension 30, which is rigidly connected to the lever 22. Accordingly, the lever 22′ has an angled extension 30′, which is not apparent in FIG. 2, wherein the ends of the extension 30′ facing away from the seat part and of the extension associated with the lever 22′ are connected to an axle-like brace 32 in an articulated manner.

In the region of the end of the extension 30 facing away from the seat part, one end of a spring element in the form of a gas pressure spring or gas spring 34 is connected to the brace 32, the other end of the spring being connected in an articulated manner to a first side part 36 of the calf support part 20. Accordingly, one end of a further spring element in the form of a gas spring 34′, which is not apparent from FIG. 2, is connected to the lever 22′, the other end of the spring being connected to a second side part 36′ of the calf support part 20.

The calf support part 20 is mounted pivotably about a second pivot axis 38, the free ends of the axis being guided in a straight guide in the form of a slot 40, which is straight in this exemplary embodiment and formed on the first side part 36, and in a guide in the form of a slot 40′ in the second side part 36′, the guide being configured accordingly. At a distance from the free ends and configured substantially at the center between the ends, the second pivot axis in the form of a crank 42 is provided, which is connected to a spindle nut 44 in an articulated manner, which is disposed non-rotatably and displaceably in the axial direction on a rotationally driven threaded spindle 46, which has a rotary drive connection to an electric motor 50 via a transmission 48.

Towards the seat part 16, the crank 42 comprises extensions 52, 52′, which are rigidly connected to the second pivot axis 38 and end in lugs 54, 54′, between which one end of a further spring element in the form of a further gas spring 56 is received and connected in an articulated manner. The lugs 54, 54′ are rigidly connected to a further axle-like brace 57, the free end of the brace being rigidly connected to the levers 22, 22′ at a distance from the free ends thereof in the region of the extensions 30, 30′s. The other end of the further gas spring 56 is rigidly connected to the axle-like brace 32, the ends thereof being mounted rotatably on the ends of the extensions 30, 30's of the levers 22, 22′ facing away from the seat part 16.

The operating principle of the adjusting mechanism shown according to FIG. 2 is as follows:

If, proceeding from the position of the spindle nut 44 shown in FIG. 2, the electric motor 50 drives the threaded spindle 46 such that the spindle nut 44 in FIG. 2 moves to the left, the second pivot axis 38 performs a translatory motion in the slots 40, 40′, thus displacing the calf support part 20 relative to the levers 22, 22′ in a translatory manner until the second pivot axis 38 comes to a halt at the ends of the slots 40, 40′ facing away from the seat part 16. In this way, the gas springs 34, 34′ guarantee that the calf support part 20 is displaced relative to the levers 22, 22′ exclusively in a translatory manner.

If, proceeding from the resulting adjustment position, the electric motor 50 drives the spindle nut such that the nut moves to the right according to FIG. 2, the calf support part 20 is displaced relative to the levers 20, 22 in the opposite direction in a translatory manner until the adjustment position shown in FIG. 2 has been reached, in which the second pivot axis 38 comes to a halt at the ends of the slots 40, 40′ facing the seat part 16.

If, proceeding from the resulting adjustment position shown according to FIG. 2, the electric motor 50 then further drives the threaded spindle 46 such that the spindle nut 44 moves further to the right according to FIG. 2, the calf support part 20 is pivoted against the action of the gas springs 34, 34′ relative to the levers 22, 22′ and hence relative to the leg support part 16 about the second pivot axis 38, which is to say counterclockwise according to FIG. 2. Depending on the respective requirements, the stroke of this pivot motion can be selected such that the calf support part 20 can be displaced in an adjustment position, in which it is disposed substantially perpendicular, so that the support surfaces of the seat part 16 and of the calf support part 20 are disposed substantially perpendicular to each other.

FIG. 3 shows a further detail from the area of the adjusting mechanism for adjusting the calf support part 20 relative to the seat part 16.

On the seat part 16, a sliding block guide is provided, which is formed by two sliding blocks 58, 58′, which are disposed laterally at a distance from and parallel to each other, only the sliding block 58 being apparent in FIG. 3. The sliding block 58 has a straight section 60, which transitions into a section configured as a bevel 62 at the end facing the calf support part 20. The sliding block 58′ is configured in the same manner.

The lever 22 is guided with the pins 26, 28 thereof in the sliding block 58, while the lever 22′ is guided with the pins 26′, 28′ thereof is guided in the sliding block 58′.

A spindle nut, which is not apparent from FIG. 3 and which is disposed non-rotatably and displaceably in the axial direction on a rotationally driven threaded spindle, is connected non-displaceably to the brace 24 connecting the levers 22, 22′, the spindle being hidden in FIG. 3 by a cover 64 and rotationally driven by an electric motor 66.

The operating principle of the adjusting mechanism shown according to FIG. 3 is as follows:

If the electric motor 66 drives the threaded spindle such that the spindle nut connected to the brace 24 moves to the right according to FIG. 3, the pins 26, 28 or 26′, 28′ move along the sliding blocks 58 or 58′. The pins 26, 28 or 26′, 28′ first slide off the bevel 62 and then transition into the straight sections 60, 60′ so that in this adjustment direction the front end of the calf support part 16, which is to the say the end facing the seat part 16, is pivoted first and lowered and thereafter moved to the right relative to the seat part 16 according to FIG. 3, corresponding to the straight course of the sliding blocks 58, 58′, so that the calf support part 20 is displaced underneath the seat part 16, as is shown according to FIG. 6.

If, proceeding from the resulting adjustment position, the electric motor 66 drives the threaded spindle such that the spindle nut connected to the brace 24 is moved to the left according to FIG. 3 along the sliding blocks 58, 58′, the calf support section 20 is first displaced in a translatory manner and substantially parallel to the seat part 16 until the pins 26, 26′ come in contact with the bevels 62, 62′. Upon contact of the pins 26, 26′ with the bevels 62, 62′, the calf support part 20 performs a clockwise pivot motion, so that the rear end thereof in this adjustment direction, which is to say the end facing the seat part 16 and symbolized in FIG. 3 by an arrow 68, is lifted until the end has substantially the same height as the seat part 16 shown in FIG. 1.

Details of the interaction between the adjusting mechanism shown according to FIG. 2 and the adjusting mechanism shown according to FIG. 3 will be explained in more detail below with reference to FIGS. 6 to 9.

FIG. 4 shows a detail from the region of an adjusting mechanism for adjusting the second backrest part 10 relative to the first backrest part 8. The second backrest part 10 is mounted pivotably about a third pivot axis 70 symbolized in FIG. 4 by a dash-dotted line on the first backrest part 8, and specifically via levers 72, 72′ disposed laterally at a distance from each other. The lever 72′ is used to non-rotatably connect a set of lugs 74, 74′, which have a drive connection to the spindle nut, which is not shown in FIG. 4, for pivoting the levers 72, 72′. The spindle nut is disposed non-rotatably and displaceably in the axial direction on a rotationally driven threaded spindle 76, which has a rotary drive connection via a transmission 78 to an electric motor 80. The spindle nut, which is not shown, is connected to the lugs 74, 74′, for example, via a lever configuration in an articulated manner such that the levers 72, 72′ are pivoted counterclockwise about the third pivot axis 70 according to FIG. 4 when the spindle nut according to FIG. 4 is moved upward.

The second backrest part 10 is mounted pivotably about a pivot axis 82 symbolized in FIG. 4 on the levers 72, 72′, wherein an adjusting mechanism for pivoting the second backrest part 10 relative to the levers 72, 72′ about the fourth pivot axis 82 has an equivalent configuration to that described for the adjusting mechanism for pivoting the levers 72, 72′ about the third pivot axis 70 relative to the first backrest part 10.

FIG. 5 illustrates details of this adjusting mechanism comprising an electric motor 84, which has a rotary drive connection via a transmission 86 to a threaded spindle 88 on which a spindle nut, which is not shown in FIG. 5, is disposed non-rotatably and displaceably in the axial direction, the nut being connected to lugs 90, 90′ that are non-rotatably connected to the lever 72 via a lever configuration, which is not shown, such that the second backrest part 10 is pivoted about the fourth pivot axis 82 relative to the first backrest part 8 when the spindle nut moves.

As a result, the pivot strokes achieved upon pivoting about the third pivot axis 70 or the fourth pivot axis 82 add up.

So as to pivot the headrest part 14 relative to the second backrest part 10, an adjusting mechanism is provided, which is not shown in detail in the figure, however which is designed as described above for the adjusting mechanisms for pivoting the second backrest part 10 relative to the first backrest part 8.

The interaction of the adjusting mechanisms will be explained in more detail hereinafter with reference to FIGS. 6 to 9.

FIG. 6 shows an adjustment position of the support parts 8, 10, 14, 16, 20 of the armchair 2, the position corresponding to a sitting position.

In this sitting position, the calf support part 20 is disposed underneath the seat part 16 so that in this position the calf support part 20 and the seat part 16 are disposed on top of each other in the direction of an imaginary line indicated by an arrow 92 in FIG. 6, the imaginary line being perpendicular to the support surfaces of the calf support part 20 and of the seat part 16.

In the sitting position, furthermore the first backrest part 8 has a substantially vertical position. Furthermore, in the sitting position, the second backrest part 10 is pivoted by a maximum pivot angle relative to the first backrest part 8, so that the support surfaces of the backrest parts 8, 10 point away from each other. Furthermore, in the sitting position, the headrest part 14 is pivoted by a maximum pivot angle relative to the second backrest part 10, so that the support surfaces of the headrest part 14 and of the second backrest part 10 form approximately a right angle with one another and thus point away from each other.

In this sitting position, the headrest part 14 and the second backrest part 10 are received behind the first backrest part 9 and are therefore hidden by the same, viewed from the front of the armchair. Since the calf support part 20 is received underneath the seat part 16, the armchair 2 in this sitting position conveys the overall aesthetic impression of a conventional armchair with a substantial cubic design.

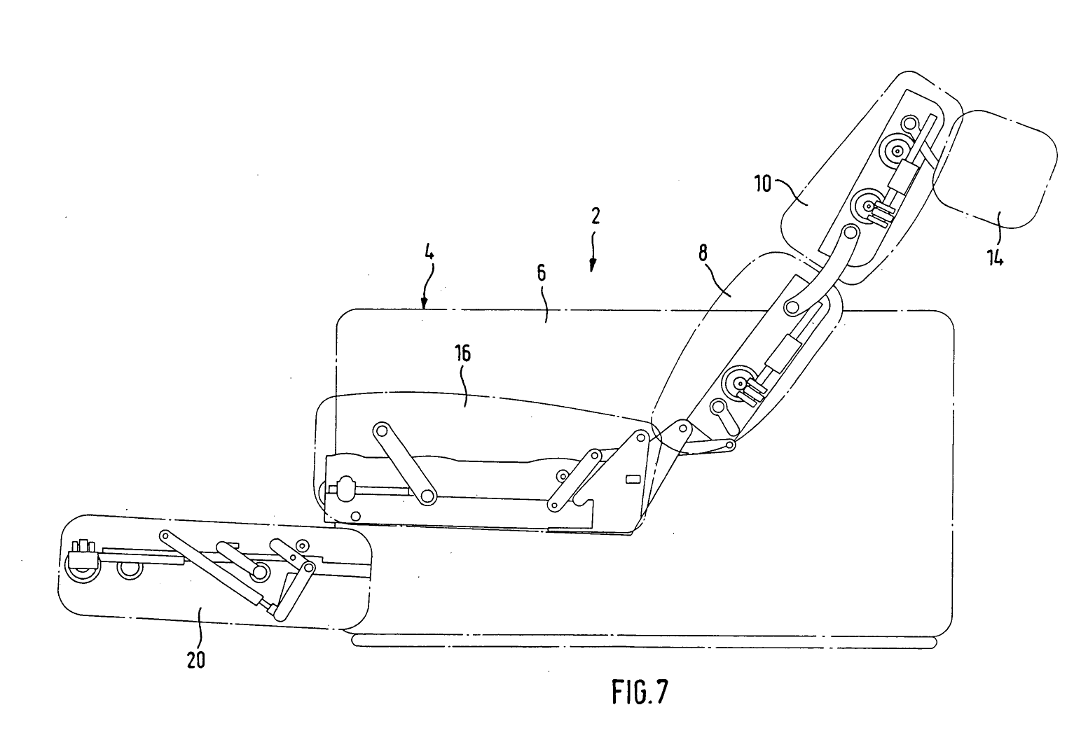

Starting from this sitting position, first the associated adjusting mechanism pivots the second backrest part 10 relative to the first backrest part 8 until the adjustment position shown according to FIG. 7 has been reached, in which the support sides of the backrest parts 8, 10 point substantially in the same direction, such that the backrest parts 9, 10 form a common support surface, as is shown in FIG. 7.

Simultaneously with the pivoting of the second backrest part 10 relative to the first backrest part 8, or offset by a time interval thereto, the calf support part is displaced relative to the seat part 16 in the sliding blocks 58, 58′ via the associated adjusting mechanism, so that the part is first moved in a translatory manner and substantially parallel to the seat part 16 and out from underneath the same, as is shown according to FIG. 7.

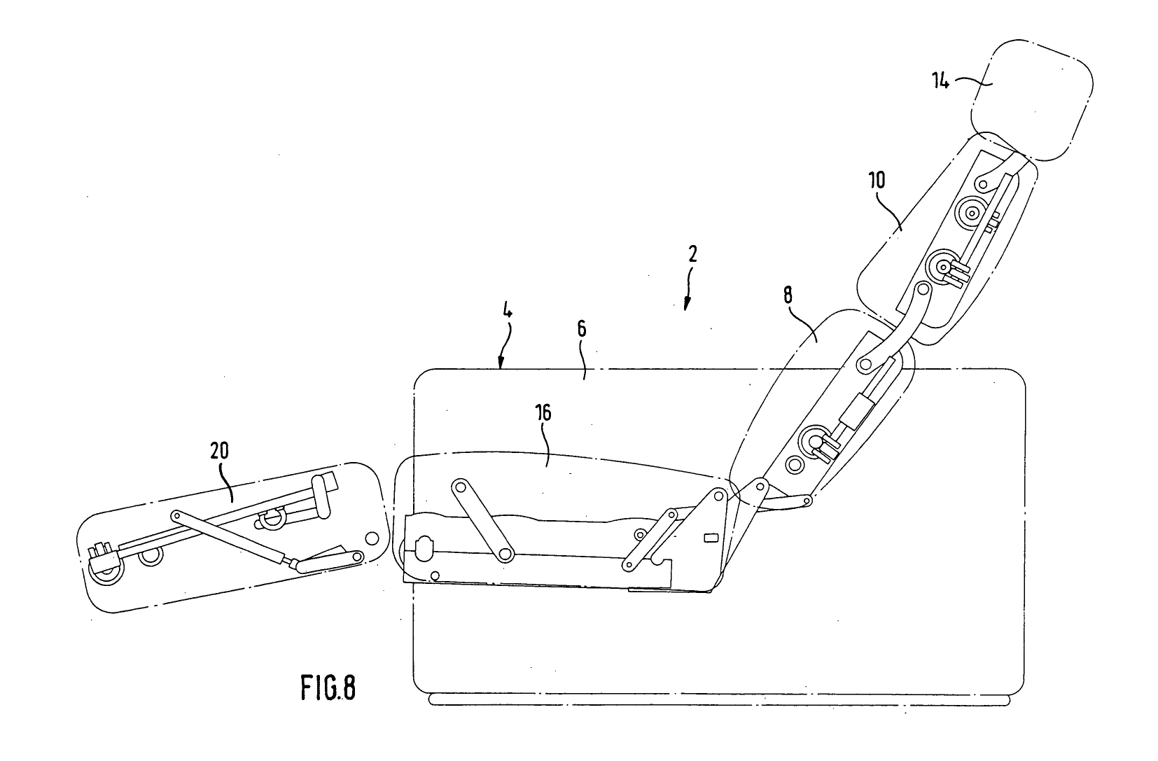

Starting from the subsequent adjustment position shown according to FIG. 7, the headrest part 14 is then pivoted counterclockwise relative to the second backrest part 10 by the associated adjusting mechanism until the position shown in FIG. 8 has been reached, in which the support sides of the first backrest part 8, of the second backrest part 10 and of the headrest part 14 point substantially in the same direction such that they form a common, substantially continuous support surface.

At the same time, or offset by a time interval thereto, the calf support part 20 is displaced further along the sliding blocks 58, 58′ via the associated adjusting mechanism until the pins 26, 26′ come in contact with the bevels 62, 62′, so that the calf support part performs a clockwise pivot motion in FIG. 7 and hence the support surface of the calf support part 20 is raised in the region of the end facing the leg support part 16 until it has the height of the support surface of the seat part 16, which is indicated in FIG. 8.

Since also the end of the calf support part 20 facing away from the seat part 16 is lifted due to the pivot motion, the calf support part 20 is pivoted at the same time counterclockwise about the second pivot axis according to FIG. 8 via the associated adjusting mechanism. In this way, it is achieved on the one hand that the support surfaces of the calf support part 20 and of the seat part 16 have the same heights at the end of the associated pivot motion, and on the other hand it is prevented that the end of the calf support part 20 facing away from the seat part 16 is pivoted counterclockwise in an undesirable manner and protrudes upward. The pivot motion about the second pivot axis 80 thus completely, or at least partially, compensates for the pivot motion caused by the bevels 62, 62′.

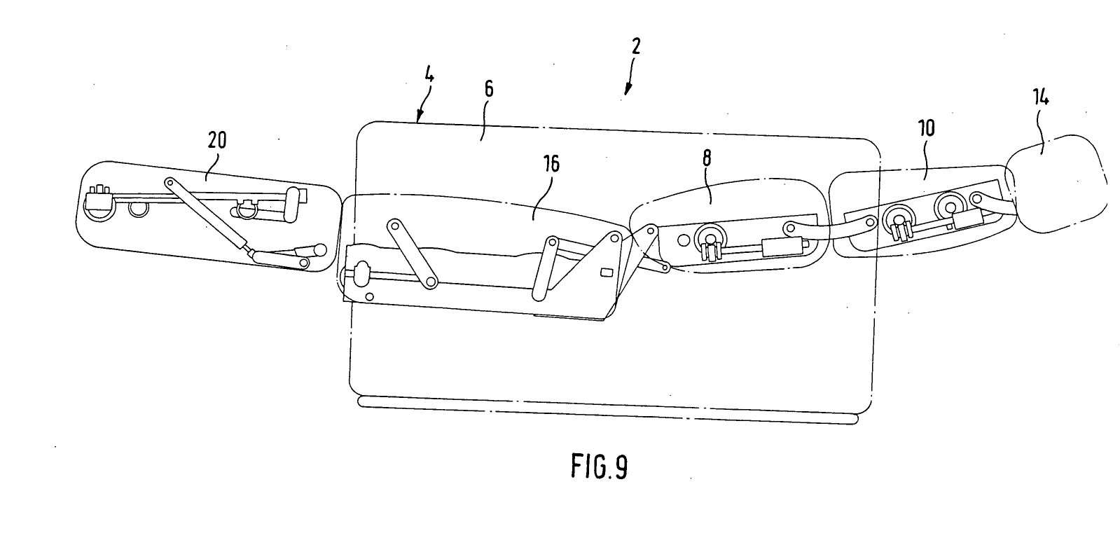

At the end of this adjusting movement, the calf support part 20 and the seat part 16 are disposed next to each other, wherein the support surfaces thereof form a common, substantially continuous support surface and the support surfaces point substantially in the same direction, which is to say upward according to FIG. 9.

So as to move the armchair 2 in a reclining position, the first backrest part 8 is pivoted clockwise relative to the seat part about the first pivot axis 18 according to FIG. 8, either at the same time or offset by a certain time interval, until the adjustment position shown in FIG. 9 has been reached, which corresponds to a reclining position of the armchair. As is apparent from FIG. 9, in this reclining position the support surfaces of the calf support part 20, of the seat part 16, of the first backrest part 8, of the second backrest part 10 and of the headrest part 14 form a common, substantially continuous support surface, on which also tall individuals may repose.

The inventive armchair offers numerous adjustment possibilities and is particularly comfortable.

The configuration according to FIG. 2 comprising the gas springs 34, 34′ and 56 is of particularly inventive significance. The invention underlying this configuration is to provide a load-limiting device to protect the adjusting mechanism for adjusting the calf support part 20 relative to the seat part 16 from damage by excessive load. The load-limiting device prevents damage to the adjusting mechanism, particularly to the levers 22, 22′ and the components connected thereto, for example from bending, when the drive mechanism is out of operation and a manual load is applied to the calf support part. In the event that a load is applied to the left end of the calf support part 20 according to FIG. 2, for example, while the drive mechanism is out of operation, which is to say the electric motor 50 is out of operation, for example, and a person sits down on this end, the calf support part 20 pivots counterclockwise about the second pivot axis 38 in FIG. 2, and particularly against the action of the gas springs 34, 34′. Since the gas springs 34, 34′ are spring-loaded and resiliently yield, damaging forces cannot be introduced in the levers 22, 22′ and the components connected thereto. At the end of the spring travel of the gas springs 34, 34′, the calf support part 20 pivots further, wherein the brace 32 rotates relative to the extensions 30, 30′ of the levers 22, 22′, and particularly against the action of the further gas spring 56.

In this way, load-limiting protection is achieved for the adjusting mechanism for adjusting the calf support part 20 relative to the seat part 16 and the introduction of damaging forces in the levers 22, 22′ and the components connected thereto is prevented. Such a load-limiting device can also be applied to an adjusting mechanism of different support parts, for example for adjusting the first backrest part relative to the seat part, or to any arbitrary support parts. According to a further development of the underlying invention, the load-limiting device comprises a spring device, which are spring-loaded and give way when a load is applied. A further development provides that first spring device and second spring device is provided, wherein the spring device is actuated during different kinematic phases while a manual load is applied to the support part.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. An armchair, comprising:
a) a base body;
b) a backrest provided on the base body, the backrest being configured to support a person reposing on the armchair in a back region, in use; and
c) the backrest including at least two connected backrest parts, which can be angularly displaced and adjusted relative to each other.

2. An armchair according to claim 1, wherein:
a) the at least two backrest parts can be adjusted relative to each other between:
i) a first adjustment position, in which respective support parts defining support sides of the backrest parts face substantially in the same direction such that the support parts define a common support surface; and
ii) a second adjustment position, in which the support sides of the backrest parts face away from each other.

3. An armchair according to claim 2, wherein:
a) in the second adjustment position respective backs of the backrest parts facing away from the support sides face each other, and rest against each other in some areas.

4. An armchair according to claim 3, wherein:
a) a seat part is provided on the armchair, and the seat part is angularly displaceably and adjustably connected to an end of the first backrest part facing away from the second backrest part.

5. An armchair according to claim 4, wherein:
a) in a first adjustment position of the first backrest part relative to the seat part, the support sides of the first backrest part and of the seat part face substantially in the same direction such that the first backrest part and the seat part in this adjustment position form a common support surface, and, in a second adjustment position the support sides of the first backrest part and of the seat part form an acute angle with each other.

6. An armchair according to claim 4, wherein:
a) a headrest part is connected to the end of the second backrest part facing away from the first backrest part, the headrest part being angularly displaceable and adjustable relative to the second backrest part.

7. An armchair according to claim 6, wherein:
a) in a first adjustment position of the headrest part relative to the second backrest part, the support sides of the headrest part and of the backrest part face substantially in the same direction, such that the headrest part and the second backrest part form a common support surface, while in a second adjustment position the support sides of the second backrest part and of the headrest part point away from each other.

8. An armchair according to claim 5, wherein:
a) in the second adjustment position of the headrest part relative to the second backrest part, the backs of the headrest part facing away from the support sides and of the second backrest part face each other.

9. An armchair according to claim 3, wherein:
a) a calf support part is connected angularly displaceably and adjustably to the end of the seat part facing away from the first backrest part.

10. An armchair according to claim 9, wherein:
a) at least one of:
i) the first backrest part is pivotably connected to the second backrest part; and
ii) the first backrest part is pivotably connected to the seat part; and
iii) the second backrest part is pivotably connected to the headrest part; and
iv) the seat part is pivotably connected to the calf support part; and
v) each one of the first backrest part, the second backrest part, and the seat part is connected about at least one pivot axis.

11. An armchair according to claim 9, wherein:
a) at least one of:
i) the first backrest part is adjustable relative to the second backrest part; and
ii) the first backrest part is adjustable relative to the seat part; and
iii) the headrest part is adjustable relative to the second backrest part; and
iv) the calf support part is adjustable relative to the seat part by an electromechanical drive device.

12. An armchair according to claim 9, wherein:
a) in a reclining position of the armchair the support sides of the calf support part, of the seat part, of the first backrest part, and of the second backrest part, and of the headrest part define a common reclining surface, such that the armchair forms a reclining part of furniture.

13. An armchair, comprising:
a) a base body;
b) a at least one first support part and second support part provided on the base body;
c) the at least one first support part and second support part having support surfaces configured to support a person reposing on the armchair, in use;
d) the first support part can be displaced relative to the second support part between:
i) a first adjustment position, in which the support parts are disposed on top of each other in the direction of an imaginary line perpendicular to at least one of the support surface; and
ii) a second adjustment position, in which the first and second support parts are disposed in line next to each other and the support surfaces thereof form a common, particularly substantially continuous support surface.

14. An armchair according to claim 13, wherein:
a) the first support part is disposed underneath the second support part in the first adjustment position.

15. An armchair according to claim 13, wherein:
a) the first support part performs a pivot motion at least partially between the first adjustment position and the second adjustment position.

16. An armchair according to claim 13, wherein:
a) the first support part performs a linear translatory motion at least partially between the first adjustment position and the second adjustment position.

17. An armchair according to claim 13, wherein:
a) a sliding block guide is provided; and
b) the first support parts is guided on the second support part by the sliding block guide.

18. An armchair according to claim 17, wherein:
a) the sliding block guide includes at least one straight section.

19. An armchair according to claim 17, wherein:
a) the sliding block guide includes at least one section, which is one of a curved and an angled, and extending to a straight section, such that the first support part performs a pivot motion when passing this section, in use.

20. An armchair according to claim 19, wherein:
a) the one of a curved and an angled section extends such that the sliding block guide raises the rear end of the first support part in the adjustment direction upon displacement of the first support part in the second adjustment position.

21. An armchair according to claim 20, wherein:
a) a device is provided, which, as the first support part passes the one of a curved and an angled section upon displacement of the first support part in the second adjustment position, in use, lowers the front end of the first support part in the adjustment direction such that the support surface of the first support part is or remains disposed substantially horizontally when the first support part passes the one of a curved and an angled section of the sliding block guide, in use.

22. An armchair according to claim 21, wherein:
a) in use, the rear end of the first support part in the adjustment direction is pivoted about a first pivot axis as the first support part passes the one of a curved and an angled section of the sliding block guide during displacement in the second adjustment position, while the front end of the first support part in the adjustment direction is pivoted clockwise about a second pivot axis, which is substantially parallel to the first pivot axis.
